(19) United States
(12) Patent Application Publication
(10) Pub. No.: US 2005/0166871 A1
(43) Pub. Date: Aug. 4, 2005

(54) Internal combustion engine with heat exchanger

(76) Inventor: Edward Lawrence Warren, West Melbourne, FL (US)

Correspondence Address: Edward L. Warren, 3912 Snowy Egret Dr., West Melbourne, FL, 32904, US

(21) Appl. No.: 10/769,657

(22) Filed: Feb. 2, 2004

(51) Int. Cl. F02B 25/08; F04B 17/05

(52) U.S. Cl. 123/51 R; 417/364

(57) ABSTRACT

Improvement to an internal combustion engine with heat exchanger to allow changing the displacement of the engine while the engine is operating by adding compressed air storage container 36, movable wall 11, fixed stop 6, bias spring 38, adjustable stop 40, adjustable stop controller 44, telescoping connecting rod 25, and pusher piston 15. In the resulting engine, compressed air from compressed air storage container 36 moves through heat exchanger high-pressure side 8 and on into cylinder 12. When the desired amount of air is in cylinder 12, inlet valve 10 closes, fuel is then added, burned, and expanded. When the pressure in cylinder 12 decreases, movable wall 11 moves back down against fixed stop 6 as expansion continues. Telescoping connecting rod 25 and pusher piston 15 enable almost constant volume heating, and keep a vacuum from forming at low power operating conditions.

### BACKGROUND—FIELD OF INVENTION

The present invention relates to an improvement to a reciprocating, internal combustion engine with a heat exchanger.

### BACKGROUND—DESCRIPTION OF PRIOR ART

The four ways to improve the most popular engine in use today are: 1. separating the compression from the expansion process, 2. compressing at almost constant temperature, 3. saving the exhaust heat and use it to heat the compressed air, and 4. changing the engine displacement to match the load while the engine runs.

The first three ways, separating the compression from the expansion process, compressing at almost constant temperature, and saving the exhaust heat and using it to heat the compressed air, were the subject of U.S. patent application Ser. Nos. 10/656,317 filed on Sep. 8, 2003 and 10/700,421 filed on Nov. 5, 2003.

The fourth way is the subject of this patent.

### SUMMARY

The fourth way, changing the engine displacement as the engine runs to match the load, is the subject of this invention.

The improvement is accomplished by adding compressed air storage container 36, movable wall 11, fixed stop 6, bias spring 38, adjustable stop 40, adjustable stop controller 44, telescoping connecting rod 25, and pusher piston 15, to an internal combustion engine with a heat exchanger.

In the resulting engine when power piston 14 reaches the top of its travel, compressed air from compressed air storage container 36 moves through heat exchanger high-pressure side 8 and on into cylinder 12. Pressure on both sides of movable wall 11 is the same; therefore, bias spring 38 is provided to move movable wall 11. Adjustable stop controller 44 controls the position of adjustable stop 40. Adjustable stop 40 allows the desired amount of compressed air into cylinder 12. When the desired amount of air is in cylinder 12, pusher piston 15 pushes power piston 14 back up to the top of its travel, inlet valve 10 closes, fuel is then added, burned, and expanded. When pressure in cylinder 12 decreases, movable wall 11 moves back down against fixed stop 6 as expansion continues.

Telescoping connecting rod 25 allows pusher piston 15 to push power piston 14 back up. When the engine is set for very small displacement, telescoping connecting rod 25 also allows pusher piston 15 to go all the way to the bottom of cylinder 12 while power piston 14 does not go all the way to the bottom.

At low power, the engine can operate on an engine cycle where compression is cooled, heat is added at constant pressure, combustion heat is added at near constant temperature, and the exhaust heat is captured and returned to the compressed air. This results in an engine that operates on a perfect thermodynamic cycle.

At higher power, the engine can operate on an engine cycle where compression is cooled, heat is added at constant pressure, combustion heat is added at near constant volume, and the exhaust heat is captured and returned to the compressed air. The result is an engine that operates on a little less than perfect thermodynamic cycle, but with higher power output.

### OBJECTS AND ADVANTAGES

The “Improved Internal Combustion Engine with Heat Exchanger” has the following advantages:

It can operate on a perfect thermodynamic cycle.

If heat is added to the compressed air at constant volume instead of constant temperature, then more work can be done with the heat that is added.

It changes the amount of air expanded by the engine to match the engine power to the load requirements.

When the load slows down it can save the inertia work and reuse it.

### DRAWING FIGURES

FIG. 1 shows preferred embodiment of the engine at the end of exhaust part of the cycle and the start of compressed air intake part of the cycle.

FIG. 2 shows preferred embodiment of the engine at the end of compressed air intake part of the cycle and the start of the pre-combustion part of the cycle.

FIG. 3 shows the preferred embodiment of the engine at the end of the pre-combustion part of the cycle and the start of the heated expansion part of the cycle.

FIG. 4 shows the preferred embodiment of the engine at the start of the constant pressure expansion part of the cycle.

FIG. 5 shows the preferred embodiment of the engine at the end of the constant pressure expansion part of the cycle.

FIG. 6 shows the preferred embodiment of the engine at the end of the heated expansion part of the cycle and the start of the exhaust part of the cycle.

FIG. 7 shows first alternate embodiment of the engine at the end of exhaust part of the cycle and the start of compressed air intake part of the cycle.

FIG. 8 shows first alternate embodiment of the engine at the end of compressed air intake part of the cycle and the start of the heated expansion part of the cycle.

FIG. 9 shows the first alternate embodiment of the engine at the start of the constant pressure expansion part of the cycle.

FIG. 10 shows the first alternate embodiment of the engine at the end of the constant pressure expansion part of the cycle.

FIG. 11 shows the first alternate embodiment of the engine at the end of the heated expansion part of the cycle and the start of the exhaust part of the cycle.

FIG. 12 shows the second alternate embodiment of the engine at the end of the heated expansion part of the cycle and the start of the air intake part of the cycle.

FIG. 13 shows the second alternate embodiment of the engine at the end of the air intake part of the cycle and the start of the compression part of the cycle.

FIG. 14 shows the second alternate embodiment of the engine at the end of the compression part of the cycle and the start of the heat recovery part of the cycle.

FIG. 15 shows the second alternate embodiment of the engine at the end of the heat recovery part of the cycle and the start of the heated expansion part of the cycle.

FIG. 16 shows the second alternate embodiment of the engine at the start of the constant pressure expansion part of the cycle.

FIG. 17 shows the second alternate embodiment of the engine at the end of the constant pressure expansion part of the cycle.

### REFERENCE NUMERALS IN DRAWINGS

2 air intake

3 air intake port

4 compressor

5 compressor exit valve

6 fixed stop

7 low power air intake port

8 heat exchanger high-pressure side

10 inlet valve

11 movable wall

12 cylinder

14 power piston

15 pusher piston

16 cylinder head

18 fuel injector

20 igniter

22 power output shaft

24 connecting rod

25 telescoping connecting rod

26 valve push rods

28 valve cams

30 exit valve

32 heat exchanger low-pressure side

34 exhaust exit

36 compressed air storage container

38 bias spring

40 adjustable stop

44 adjustable stop controller

46 lower compressor valve

48 cooler

50 upper compressor valve

51 displacer

52 compressor piston

53 displacer cam follower

54 compressor piston cam follower

55 second cooler

56 cam

57 low power valve

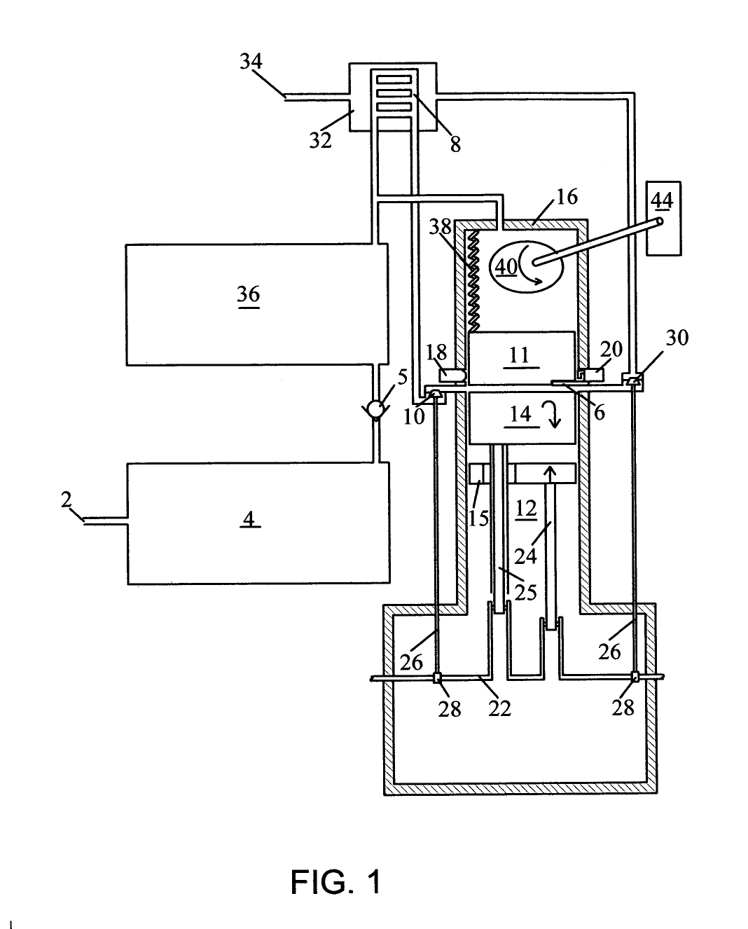

### DESCRIPTION—FIGS. 1 to 6—PREFERRED EMBODIMENT

The preferred embodiment of this invention is the addition of fixed stop 6, moveable wall 11, pusher piston 15, telescoping connecting rod 25, compressed air storage container 36, bias spring 38, adjustable stop 40, and adjustable stop controller 44 to an internal combustion engine with a heat exchanger.

The resulting engine is an internal combustion, reciprocating, regenerated engine made up of air intake 2, compressor 4, compressor exit valve 5, compressed air storage container 36, heat exchanger high-pressure side 8, power output shaft 22, heat exchanger low-pressure side 32, exhaust exit 34, and one or more similar working units. Each working unit is comprised of cylinder 12, which contains fixed stop 6, inlet valve 10, movable wall 11, power piston 14, pusher piston 15, cylinder head 16, fuel injector 18, igniter 20, connecting rod 24, telescoping connecting rod 25, valve push rods 26, valve cams 28, exit valve 30, bias spring 38, adjustable stop 40, and adjustable stop controller 44.

The engine has only one each of air intake 2, compressor 4, compressor exit valve 5, compressed air storage container 36, heat exchanger high-pressure side 8, heat exchanger low-pressure side 32, and exhaust exit 34, but it can have many working units.

To obtain maximum efficiency the compressor should operate as close to constant temperature as possible. For example, using a multi-stage-intercooled compressor with the number of stages determined by the pressure ratio of the compressor.

The airflow control is shown using check type valves and poppet type valves. These could be replaced with other type flow control devices.

Compressed air storage container 36 can also be an accumulator.

Although the air coming out of the heat exchanger high-pressure side 8 may be hot enough to ignite the fuel, igniter 20 is shown in all figures because it is needed to start the engine.

### OPERATION—FIGS. 1 to 6—PREFERRED EMBODIMENT

FIGS. 1 to 6 present the sequence of steps or processes occurring in cylinder 12. All six figures indicate that air has been taken in through air intake 2, compressed by compressor 4, stored in compressed air storage container 36, and heated going through heat exchanger high-pressure side 8 by exhaust gases flowing through heat exchanger low-pressure side 32 on their way to exhaust exit 34.

FIG. 1 shows power piston 14 approaching the top of its travel. Pusher piston 15 is moving up. Exit valve 30 is closed. Inlet valve 10 is closed. Movable wall 11 is down against fixed stop 6.

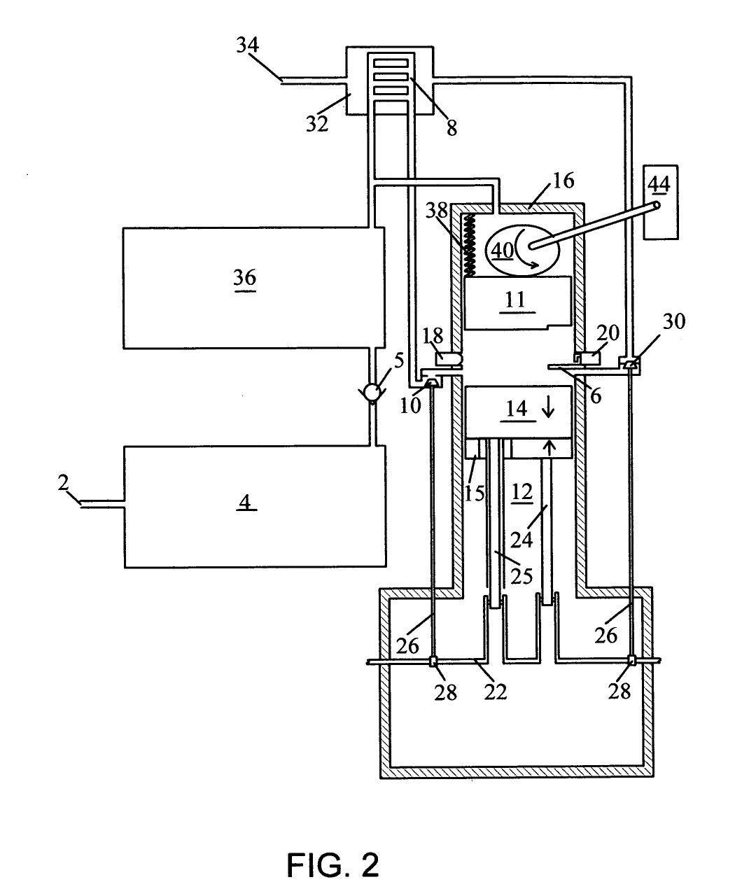

Between FIG. 1 and FIG. 2 inlet valve 10 opens. Movable wall 11 is pulled up by bias spring 38 against adjustable stop 40. Compressed air moves through heat exchanger high-pressure side 8, and expands because it is taking exhaust heat from heat exchanger low-pressure side 32. The air continues to move through inlet valve 10 into cylinder 12. Power piston 14 moves up and then down. Pusher piston 15 continues to move up and meets power piston 14.

FIG. 2 shows power piston 14 on top of pusher piston 15 that is approaching the top of its travel. Exit valve 30 is closed and inlet valve 10 is open. Movable wall 11 is up against adjustable stop 40.

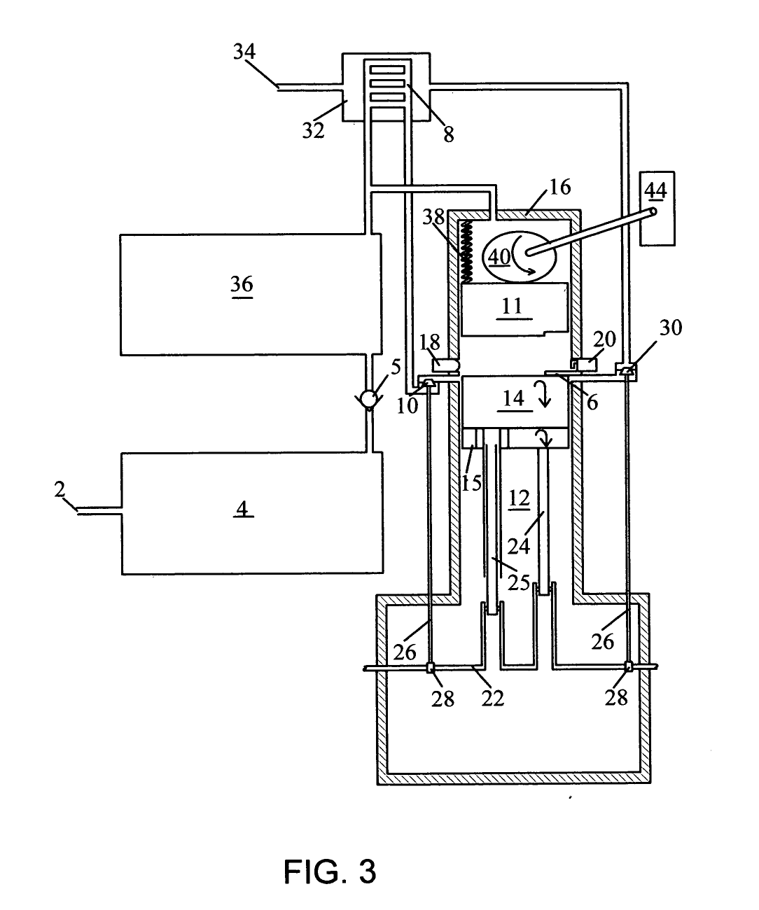

Between FIG. 2 and FIG. 3 pusher piston 15 pushes power piston 14 to the top of its travel. Inlet valve 10 closes.

FIG. 3 shows power piston 14 and pusher piston 15 at the top of the travel of pusher piston 15. Exit valve 30 is closed and inlet valve 10 is closed. Movable wall 11 is up against adjustable stop 40.

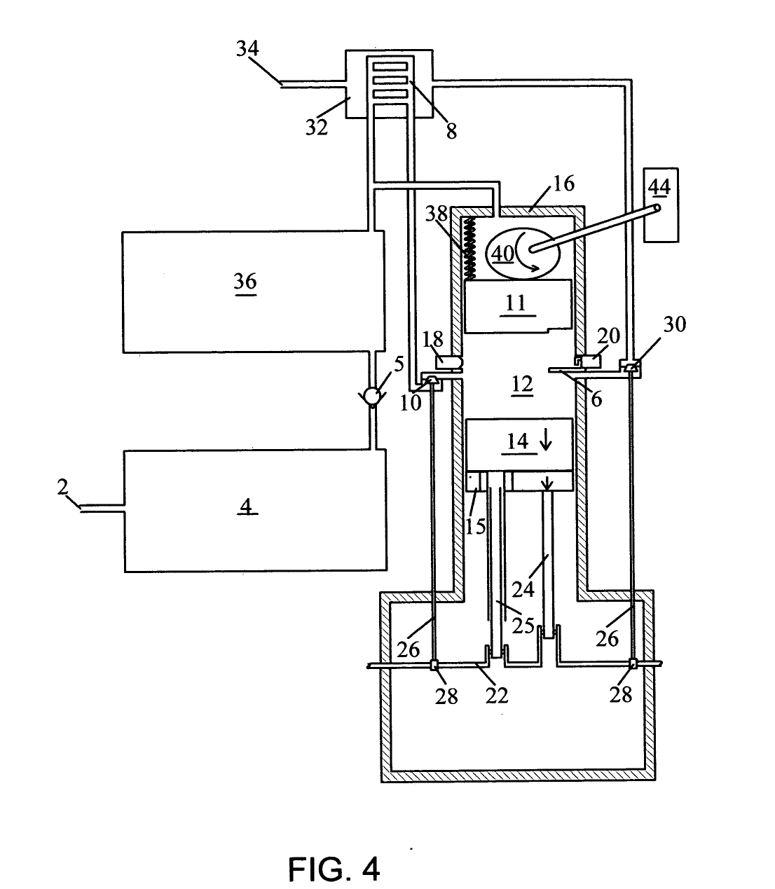

Between FIG. 3 and FIG. 4 fuel is injected and burned. The hot gases pushing down on power piston 14 and pusher piston 15 cause power to be transmitted out of the engine by power output shaft 22 to a load not shown. Power piston 14 and pusher piston 15 move down in cylinder 12.

FIG. 4 shows power piston 14 and pusher piston 15 moving down. Exit valve 30 is closed and inlet valve 10 is closed. Movable wall 11 is up against adjustable stop 40.

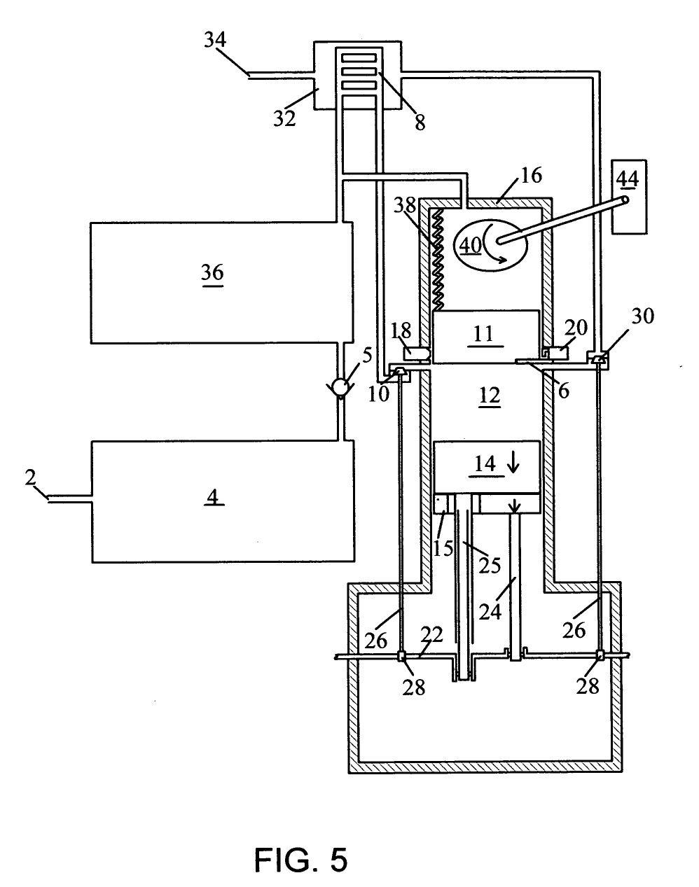

Between FIG. 4 and FIG. 5 the pressure below movable wall 11 becomes lower than the pressure above it, and compressed air from compressed air storage container 36 causes movable wall 11 to move down to fixed stop 6. The hot gases pushing down on power piston 14 and pusher piston 15 cause power to be transmitted out of the engine by power output shaft 22. Power piston 14 and pusher piston 15 continue to move down in cylinder 12.

FIG. 5 shows power piston 14 and pusher piston 15 moving down. Exit valve 30 is closed and inlet valve 10 is closed. Movable wall 11 is up against fixed stop 6.

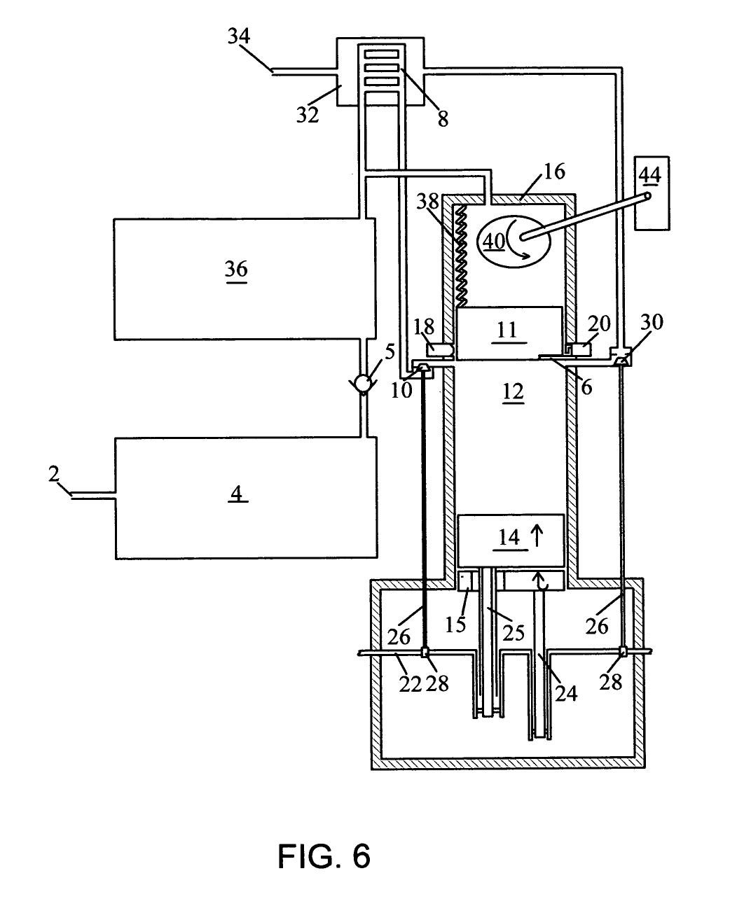

Between FIG. 5 and FIG. 6 the hot gases pushing down on power piston 14 and pusher piston 15 cause power to be transmitted out of the engine by power output shaft 22. At low power output, power piston 14 continues moving down as long as pressure forces push it, and stops if and when the pressure gets too low. Pusher piston 15 continues to move down to the bottom of cylinder 12. At high power output, power piston 14 continues moving down and then goes back up while pusher piston 15 continues to move down to the bottom of cylinder 12. Exit valve 30 opens.

FIG. 6 shows power piston 14 away from the bottom of cylinder 12, and pusher piston 15 at the bottom of cylinder 12. Exit valve 30 is open and inlet valve 10 is closed. Movable wall 11 is against fixed stop 6.

Between FIG. 6 and FIG. 1 the inertial force from a load not shown causes power output shafi 22 to continue to turn. If necessary, telescoping connecting rod 25 collapses. Power piston 14 moves up in cylinder 12. Pusher piston 15 moves up in cylinder 12. The exhaust gases are pushed out exit valve 30 through heat exchanger low-pressure side 32 where the exhaust gases give up heat to the incoming compressed air in heat exchanger high-pressure side 8. The cooled exhaust then exits the engine at exhaust exit 34. Exit valve 30 closes.

The cycle repeats.

During the above cycle adjustable stop 40 is moved to allow more or less compressed air into cylinder 12 and is controlled by adjustable stop controller 44. When more compressed air is let into cylinder 12 more power is produced. When less compressed air is let into cylinder 12 less power is produced.

The inertia from the load slowing down can be used to continue to compress air. As the engine uses less than is compressed, the extra air is stored in compressed air storage container 36. The extra air that is stored in compressed air storage container 36 can be used to allow the engine to operate at high power.

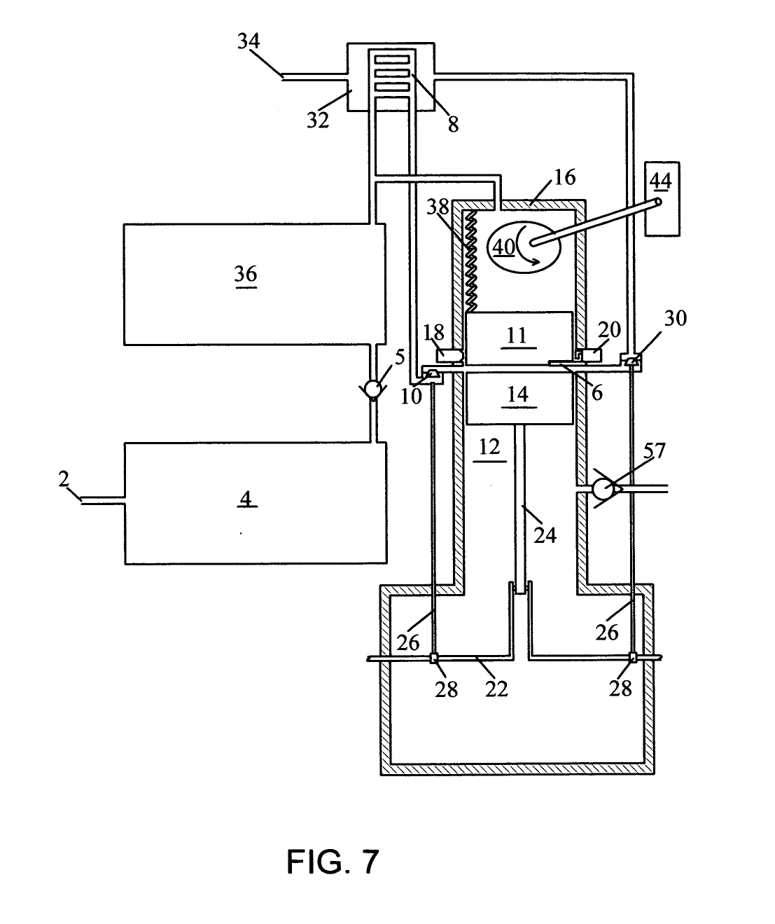

### DESCRIPTION—FIGS. 7 to 11—FIRST ALTERNATE EMBODIMENT

The first alternate embodiment of this invention is the preferred embodiment of this invention with the addition of low power valve 57 and the removal of pusher piston 15 and telescoping connecting rod 25.

The resulting engine is an internal combustion, reciprocating, regenerated engine made up of air intake 2, compressor 4, compressor exit valve 5, compressed air storage container 36, heat exchanger high-pressure side 8, power output shaft 22, heat exchanger low-pressure side 32, exhaust exit 34, and one or more similar working units. Each working unit is comprised of cylinder 12, which contains fixed stop 6, inlet valve 10, movable wall 11, power piston 14, cylinder head 16, fuel injector 18, igniter 20, connecting rod 24, valve push rods 26, valve cams 28, exit valve 30, bias spring 38, adjustable stop 40, and adjustable stop controller 44.

The engine has only one each of air intake 2, compressor 4, compressor exit valve 5, compressed air storage container 36, heat exchanger high-pressure side 8, heat exchanger low-pressure side 32, and exhaust exit 34, but it can have many working units.

To obtain maximum efficiency the compressor should operate as close to constant temperature as possible. For example, use a multi-stage-intercooled compressor with the number of stages determined by the pressure ratio of the compressor.

The airflow control is shown using check type valves and poppet type valves. These could be replaced with other type flow control devices.

Compressed air storage container 36 can also be an accumulator.

Although the air coming out of the heat exchanger high-pressure side 8 is hot enough to ignite the fuel, igniter 20 is shown in all figures because it is needed to start the engine.

### OPERATION—FIGS. 7 to 11—FIRST ALTERNATE EMBODIMENT

FIGS. 7 to 11 present the sequence of steps or processes occurring in cylinder 12. All the figures indicate that air has been taken in through air intake 2, compressed by compressor 4, stored in compressed air storage container 36, and heated going through heat exchanger high-pressure side 8 by exhaust gases flowing through heat exchanger low-pressure side 32 on their way to exhaust exit 34.

FIG. 7 shows power piston 14 approaching the top of its travel. Exit valve 30 is closed and inlet valve 10 is closed. Movable wall 11 is down against fixed stop 6.

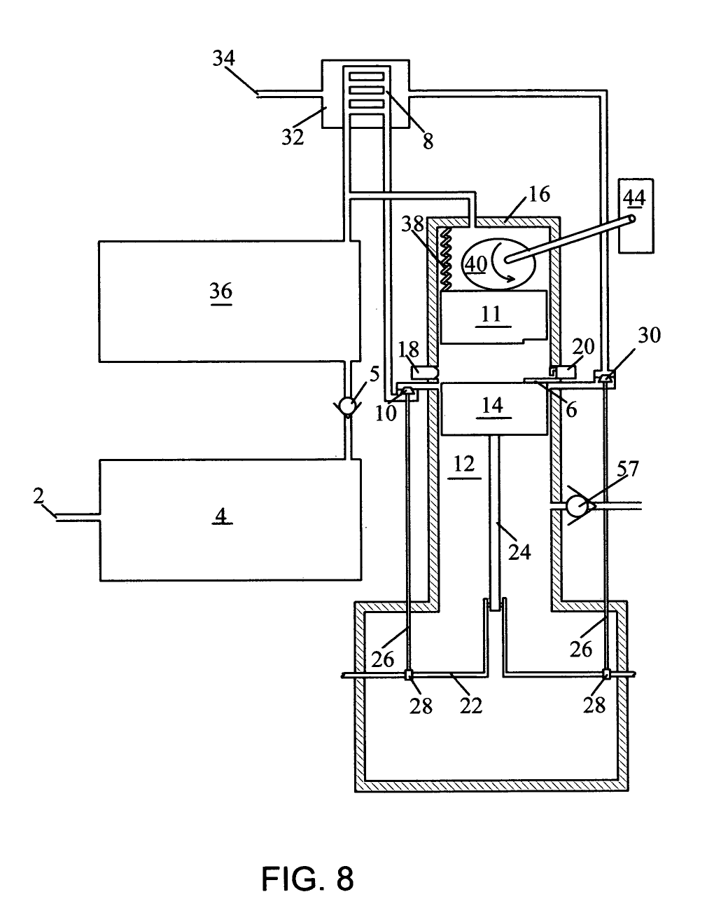

Between FIG. 7 and FIG. 8 inlet valve 10 opens, movable wall 11 is pulled up by bias spring 38 against adjustable stop 40. Compressed air moves through heat exchanger high-pressure side 8 and expands because it is taking exhaust heat from heat exchanger low-pressure side 32. The air continues to move through inlet valve 10 into cylinder 12. Inlet valve 10 closes

FIG. 8 shows power piston 14 near the top of its travel. Exit valve 30 is closed and inlet valve 10 is closed. Movable wall 11 is up against adjustable stop 40.

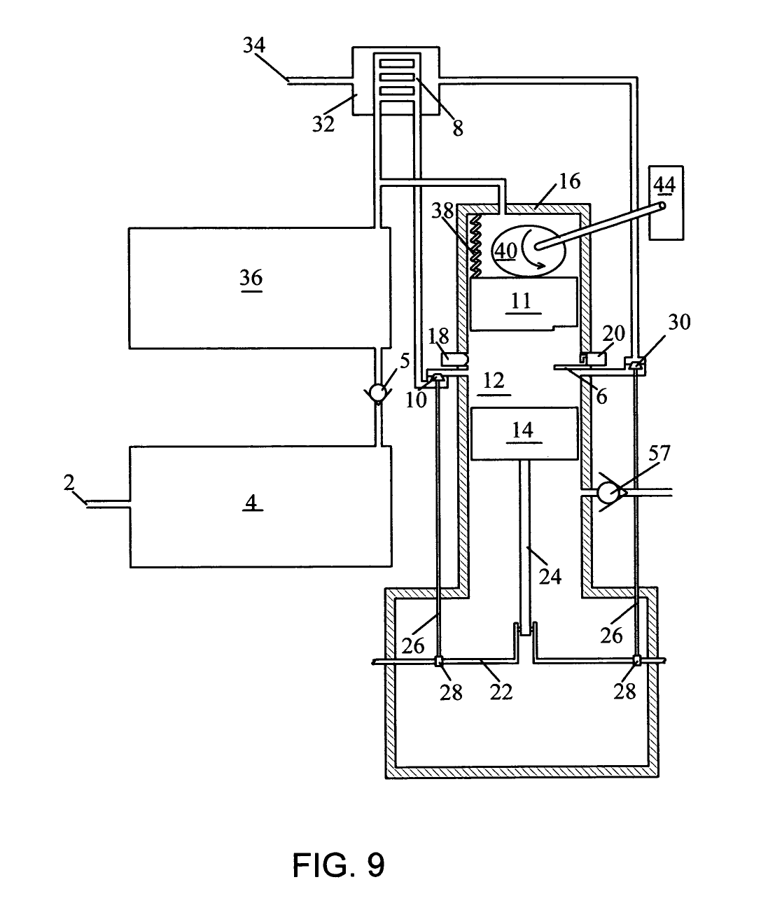

Between FIG. 8 and FIG. 9 fuel is injected and burned. The hot gases pushing down on power piston 14 cause power to be transmitted out of the engine by power output shaft 22 to a load not shown. Power piston 14 moves down in cylinder 12.

FIG. 9 shows power piston 14 moving down. Exit valve 30 is closed and inlet valve 10 is closed. Movable wall 11 is up against adjustable stop 40.

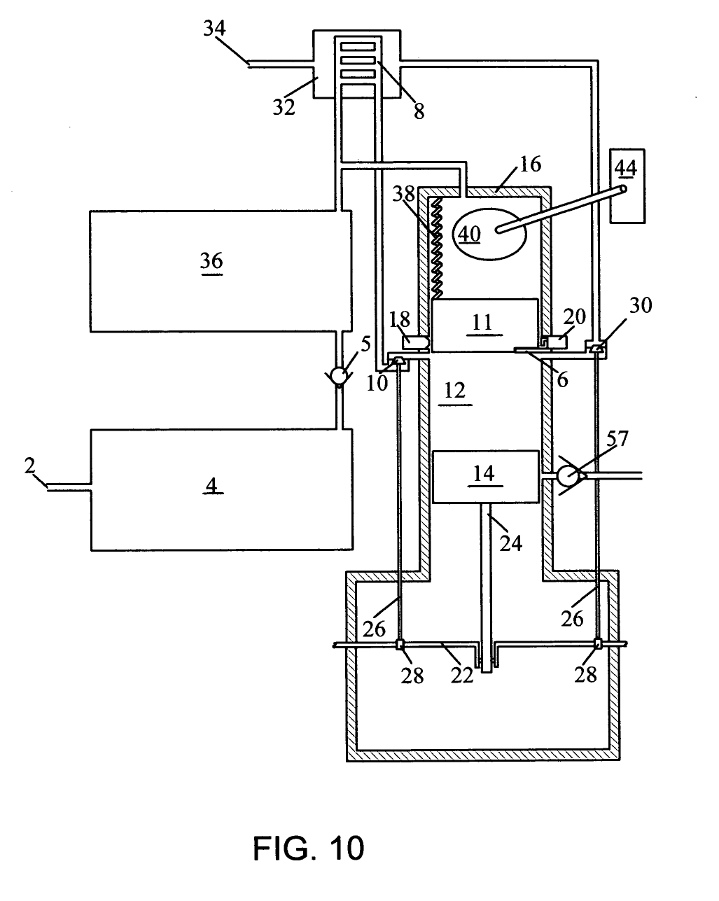

Between FIG. 9 and FIG. 10 the pressure below movable wall 11 becomes lower than the pressure above it, and compressed air from compressed air storage container 36 causes movable wall 11 to move down to fixed stop 6. The hot gases pushing down on power piston 14 cause power to be transmitted out of the engine by power output shaft 22. Power piston 14 continues to move down in cylinder 12.

FIG. 10 shows power piston 14 moving down. Exit valve 30 is closed and inlet valve 10 is closed. Movable wall 11 is against fixed stop 6.

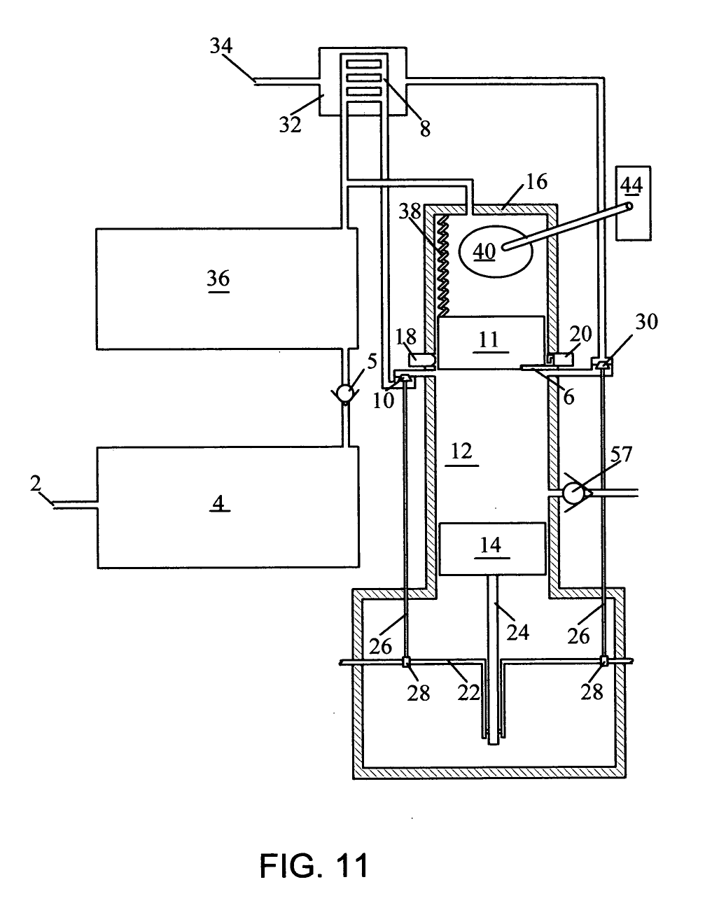

Between FIG. 10 and FIG. 11 The hot gases pushing down on power piston 14 cause power to be transmitted out of the engine by power output shaft 22. Power piston 14 continues to move down to the bottom of cylinder 12. Low power valve 57 opens if necessary at low power to prevent a vacuum from forming.

FIG. 11 shows power piston 14 at the bottom of cylinder 12. Exit valve 30 is closed and inlet valve 10 is closed. Movable wall 11 is up against fixed stop 6.

Between FIG. 11 and FIG. 7 exit valve 30 opens. The inertial force from power output shaft 22 causes power piston 14 to move up in cylinder 12. The exhaust gases are pushed out exit valve 30 through heat exchanger low-pressure side 32 where the exhaust gases give up heat to the incoming compressed air in heat exchanger high-pressure side 8. The cooled exhaust then exits the engine at exhaust exit 34.

The cycle repeats.

Adjustable stop 40 is moved to allow more or less compressed air into cylinder 12 and is controlled by adjustable stop controller 44. When more compressed air is let into cylinder 12 more power is produced. When less compressed air is let into cylinder 12 less power is produced.

The inertia from the load slowing down can be used to continue to compress air. As the engine uses less than is compressed the extra air is stored in compressed air storage container 36. The extra air that is stored in compressed air storage container 36 can be used to allow the engine to operate at high power.

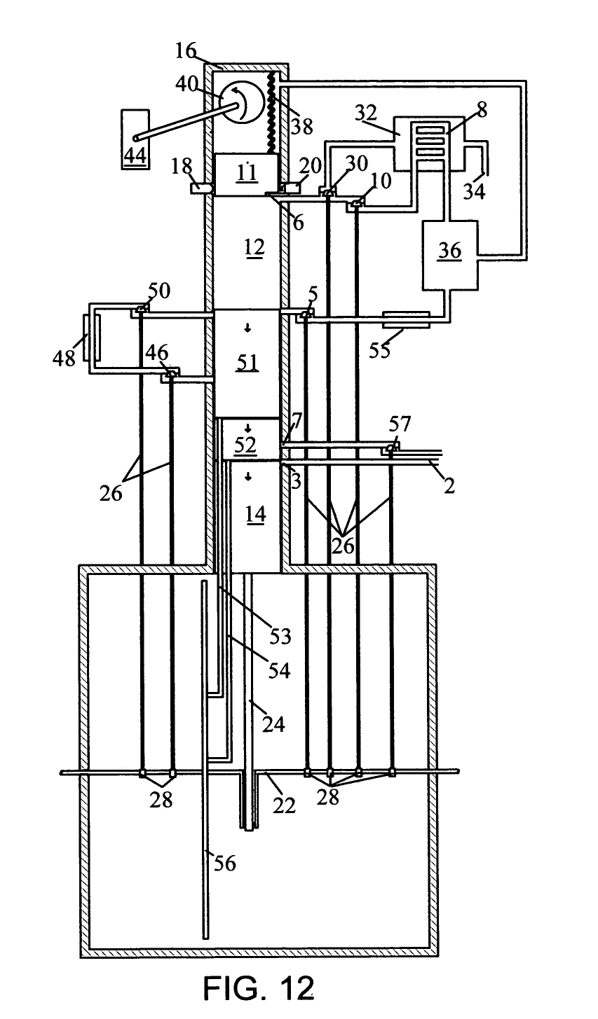

### DESCRIPTION—FIGS. 12 to 17—SECOND ALTERNATE EMBODIMENT

The second alternate embodiment of this invention is the preferred embodiment of this invention with the addition of air intake port 3, low power air intake port 7, lower compressor valve 46, cooler 48, upper compressor valve 50, displacer 51, compressor piston 52, displacer cam follower 53, compressor piston cam follower 54, second cooler 55, cam 56, and low power valve 57 and the removal of compressor 4, pusher piston 15 and telescoping connecting rod 25.

The resulting engine is an internal combustion, reciprocating, regenerated engine made up of compressed air storage container 36, second cooler 55, heat exchanger high-pressure side 8, power output shaft 22, heat exchanger low-pressure side 32, exhaust exit 34, adjustable stop controller 44, and one or more similar working units. Each working unit is comprised of cylinder 12 that is closed at one end by cylinder head 16. Air intake 2 and air intake port 3 allow air into cylinder 12 at higher power. At low power, low power valve 57 and low power air intake port 7 allow air into cylinder 12. Inside or attached to cylinder 12 are, compressor piston 52, movable wall 11, bias spring 38, adjustable stop 40, fixed stop 6, fuel injector 18, igniter 20, cooler 48, power piston 14, and connecting rod 24. Connecting rod 24 is connected to power output shaft 22, which operates cam 56 and valve cams 28. Valve push rods 26 are moved by valve cams 28. Compressor piston 52 is moved by cam 56 using compressor piston cam follower 54. Displacer 51 is moved by cam 56 using displacer cam follower 53. Lower compressor valve 46 and upper compressor valve 50 control the flow of air through cooler 48. Second cooler 55, compressed air storage container 36, and heat exchanger high-pressure side 8 are attached to cylinder 12 between compressor exit valve 5 and inlet valve 10. Exit valve 30 allows exhaust into heat exchanger low-pressure side 32 and out exhaust exit 34.

The compressor cooling system is made up of compressor piston 52, compressor piston cam follower 54, a grove in cam 56, cooler 48, lower compressor valve 46, and upper compressor valve 50. Cooler 48 cools the air as it is being compressed. Lower compressor valve 46 and upper compressor valve 50 control the air flow through cooler 48. The engine will operate without any compressor cooling systems. As many compressor cooling systems as desired may be added to the engine. The more compressor cooling systems an engine has, the closer its compression equals constant temperature compression.

The thickness of displacer 51 can be such that the compression and the expansion volumes are separated. The heat from one does not effect the other.

The engine is shown with power output shaft 22 transferring power out of the engine. Other means such as a wobble plate could be used to transfer power from the engine.

The engine is shown with cam 56 moving compressor piston 52 and displacer 51. Other means such as an actuator could move compressor piston 52 and displacer 51.

The engine is shown with poppet type valves. Other type valves could be used.

Compressed air storage container 36 can also be an accumulator.

Although the air coming out of the heat exchanger high-pressure side 8 is hot enough to ignite the fuel, igniter 20 is shown in all figures because it is needed to start the engine.

### OPERATION—FIGS. 12 to 17—SECOND ALTERNATE EMBODIMENT

The second alternate embodiment employs a two-stroke cycle, divided into four parts. The first part is the air intake part, the second is the cooled compression part, the third is the heat recovery part, and the fourth is the heated expansion part. The air intake part is from about 85% of the downward travel of power piston 14 to about 15% of the travel back up (or as measured by power output shaft 22 rotation from about 135° to about 225°). The cooled compression part is from about 15% of the travel back up of power piston 14 (225°) to about 75% of the travel back up of power piston 14 (300°). The heat recovery part is from about 75% of the travel back up of power piston 14 (300°) to about top dead center of power piston 14 (0°). The heated expansion part is from about top dead center of power piston 14 (360°) to about 85% of the downward travel of power piston 14 (135°).

The above positions are all estimates and are given for descriptive purposes only. The actual position a part of the cycle may begin or end at may be different from those set out above.

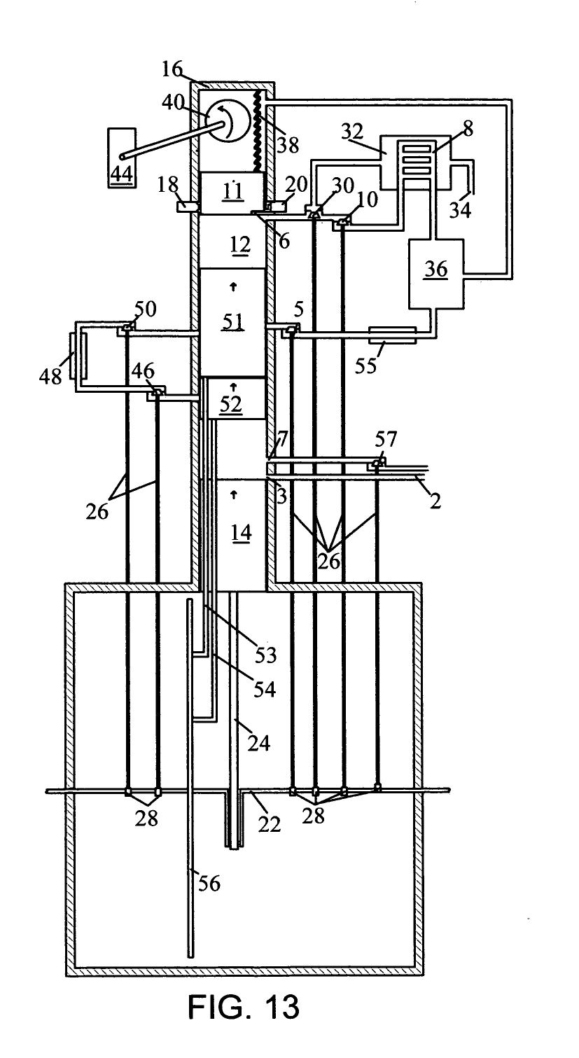

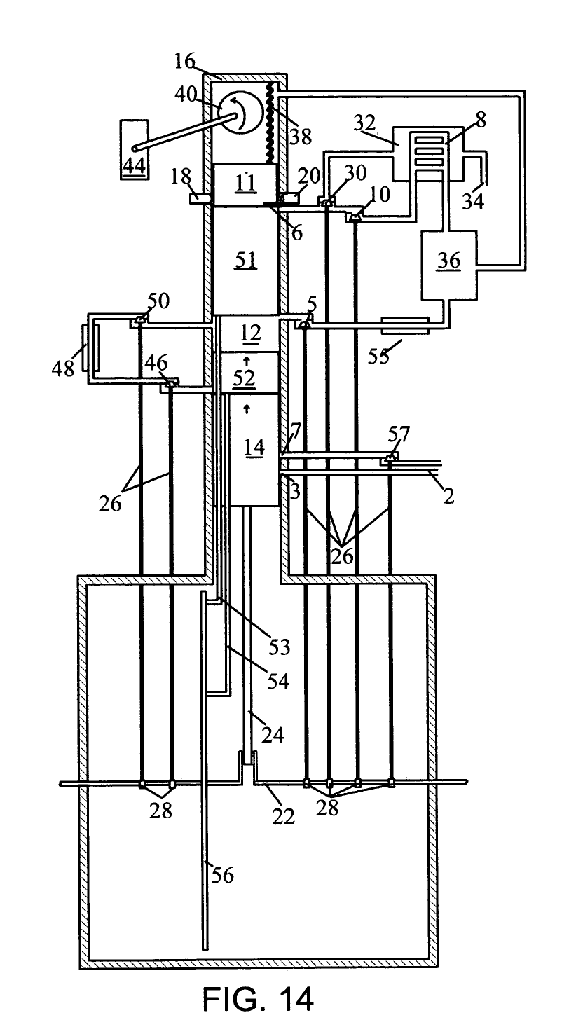

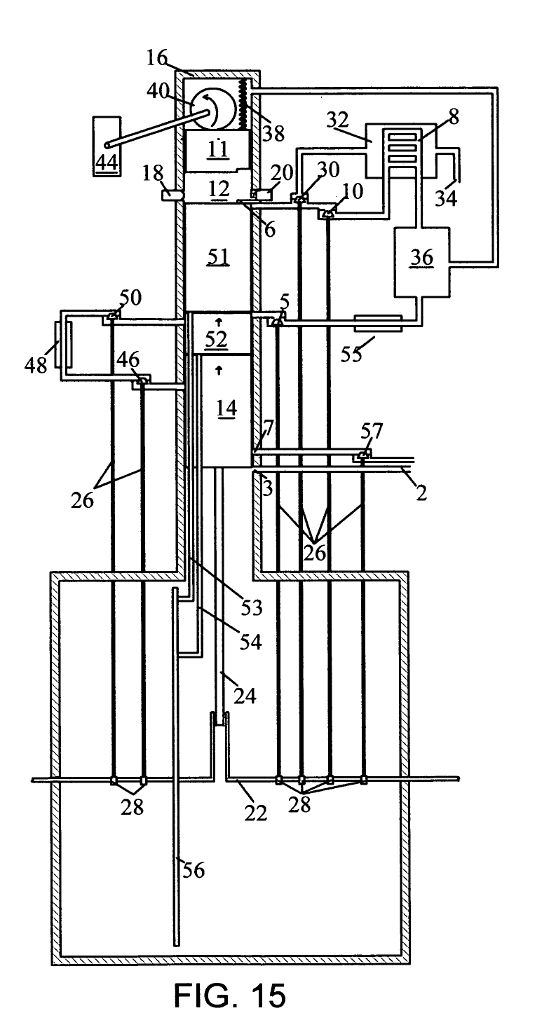

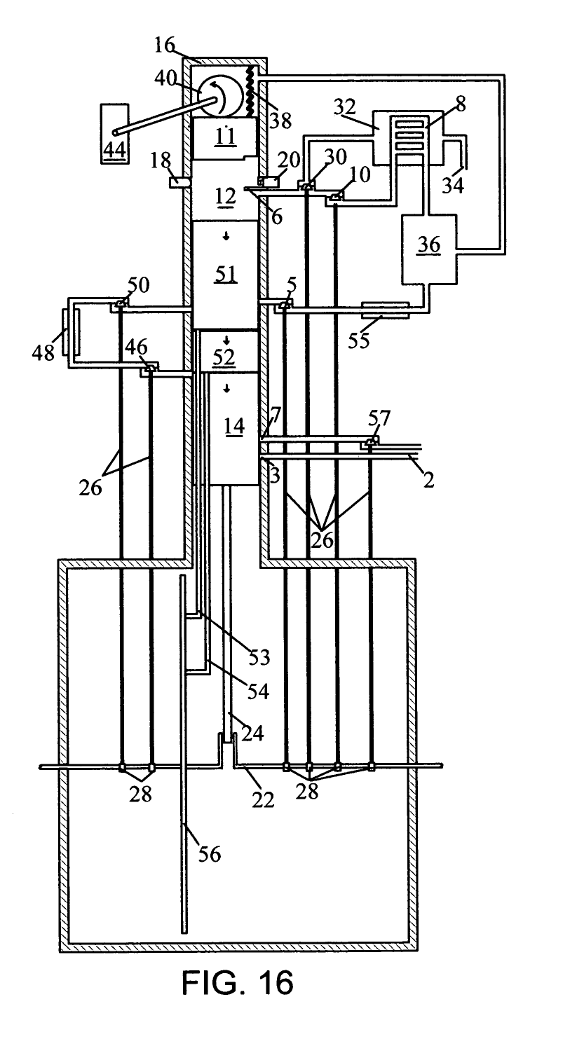

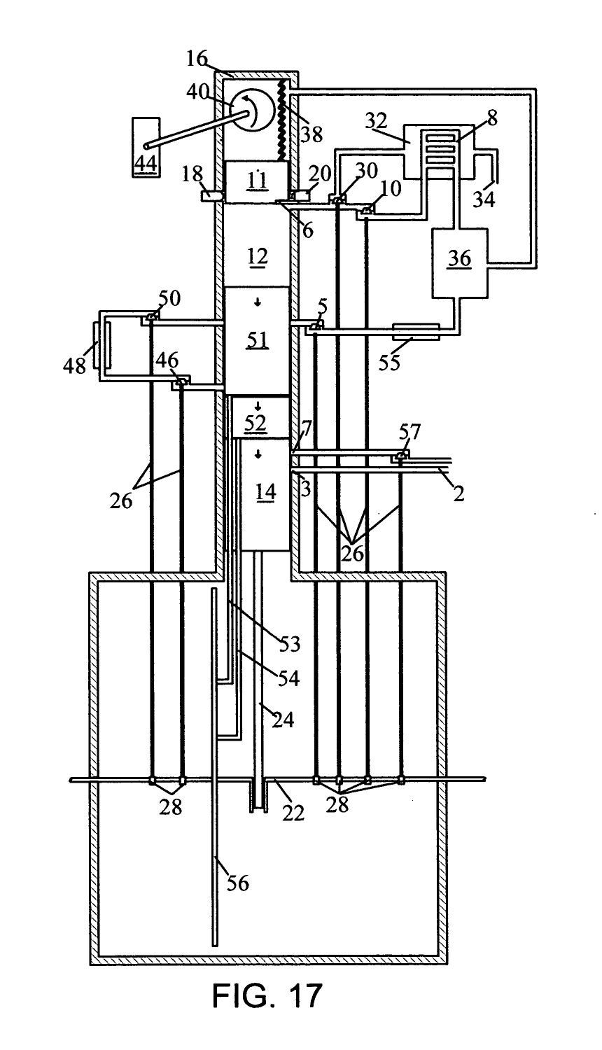

FIGS. 12 to 17 present the sequence of steps or processes occurring in the engine. The air intake part of the cycle takes place between FIGS. 12 and 13. The cooled compression part of the cycle takes place between FIGS. 13 and 14. The heat recovery part of the cycle takes place between FIGS. 14 and 15. The heated expansion part of the cycle starts in FIG. 15. The constant pressure part of the cycle starts in FIG. 16 and ends in FIG. 17. The heated expansion part of the cycle ends in FIG. 12.

FIG. 12 shows power piston 14 at about 85% of downward travel (135°). The engine has completed the heated expansion part of the cycle. Air intake port 3 is covered, (for low power operation low power valve 57 will be open and low power air intake port 7 is uncovered) exit valve 30 is closed, lower compressor valve 46 is closed, upper compressor valve 50 is closed, compressor exit valve 5 is closed, inlet valve 10 is closed, movable wall 11 is against fixed stop 6, and compressor piston 52 and displacer 51 are just above power piston 14.

Between FIG. 12 and FIG. 13 the air intake part of the cycle takes place. Exit valve 30 opens, air intake 2 is uncovered, (for low power operation low power valve 57 will be open and low power air intake port 7 is uncovered) and cam 56 moves compressor piston 52 and displacer 51 up. While displacer 51 is moving up it moves the air through exit valve 30, heat exchanger low-pressure side 32, and out of the engine through exhaust exit 34. In addition it sucks air into cylinder 12 through air intake 2. Power piston 14 continues down to the bottom of cylinder 12 and comes up again to about 15% of upward travel of power piston 14 (225°). As the air moves through heat exchanger low-pressure side 32 the air gives up heat to heat exchanger high-pressure side 8. The heat is later added back into the cycle.

FIG. 13 shows power piston 14 at about 15% of upward travel (225°). The engine has completed the air intake part of the cycle. Air intake port 3 is covered (for low power operation low power valve 57 will be open and the low power air intake port 7 is covered) valve 30 is open, lower compressor valve 46 is closed, upper compressor valve 50 is closed, compressor exit valve 5 is closed, inlet valve 10 is closed, and movable wall 11 is against fixed stop 6. Compressor piston 52 and displacer 51 are moving toward the top of cylinder 12.

Between FIG. 13 and FIG. 14 the cooled compression part of the cycle takes place. Lower compressor valve 46 and upper compressor valve 50 open. Displacer 51 moves to the bottom of movable wall 11. When displacer 51 reaches the bottom of movable wall 11 exit valve 30 closes. Power piston 14 and compressor piston 52 continue up at different rates of travel. They come together at about 75% of upward travel of power piston 14 (300°). As they are coming together, air is forced from between them through cooler 48 and compressed into the space between compressor piston 52 and displacer 51. Lower compressor valve 46 and upper compressor valve 50 close. Compressor exit valve 5 and inlet valve 10 open.

FIG. 14 shows power piston 14 at about 75% of its upward travel (300°). Air intake port 3 is covered, low power air intake port 7 is covered, exit valve 30 is closed, lower compressor valve 46 is closed, upper compressor valve 50 is closed, compressor exit valve 5 is open, inlet valve 10 is open, and movable wall 11 is against fixed stop 6. Compressor piston 52 is directly above power piston 14 and is moving up with power piston 14. Displacer 51 is at the top of its travel.

Between FIG. 14 and FIG. 15 the heat recovery part of the cycle takes place. Power piston 14 moves up to about the top of its travel (0°) moving compressor piston 52 to the bottom of displacer 51. Compressed air is moved from the space between displacer 51 and compressor piston 52 through second cooler 55, into compressed air storage container 36. From compressed air storage container 36 compressed air moves through heat exchanger high-pressure side 8, where it heats up, into the space between displacer 51 and movable wall 11. Bias spring 38 moves movable wall 11 up to adjustable stop 40. (At low power adjustable stop 40 does not allow movable wall 11 to move up as much. Compressor exit valve 5 and inlet valve 10 close.

FIG. 15 shows power piston 14 is at about top dead center. Air intake port 3 is covered, exit valve 30 is closed, lower compressor valve 46 is closed, upper compressor valve 50 is closed, compressor exit valve 5 is closed, inlet valve 10 is closed, and movable wall 11 is against adjustable stop 40. Displacer 51 is adjacent to compressor piston 52, which is adjacent to power piston 14.

Between FIG. 15 and FIG. 16 fuel is injected and burned, and the heated expansion part of the cycle takes place. Burning fuel supplies heat to the expanding air. Power piston 14, compressor piston 52, and displacer 51 move down together.

FIG. 16 shows power piston 14, compressor piston 52, and displacer 51 are moving down together. Air intake port 3 is covered, low power air intake port 7 is covered, exit valve 30 is closed, lower compressor valve 46 is closed, upper compressor valve 50 is closed, compressor exit valve 5 is closed, inlet valve 10 is closed, and movable wall 11 is against adjustable stop 40.

Between FIG. 16 and FIG. 17 the pressure force above movable wall 11 becomes greater than the pressure force below movable wall 11, and movable wall 11 moves down to fixed stop 6. Power piston 14, compressor piston 52, and displacer 51 continue to move down together.

FIG. 17 shows power piston 14, compressor piston 52, and displacer 51 are moving down together. Air intake port 3 is covered, low power air intake port 7 is covered, and the passage from low power valve 57 is covered, exit valve 30 is closed, lower compressor valve 46 is closed, upper compressor valve 50 is closed, compressor exit valve 5 is closed, inlet valve 10 is closed, and movable wall 11 is against fixed stop 6.

Between FIG. 17 and FIG. 12 the pressure force above power piston 14, compressor piston 52, and displacer 51 continues to move them down together.

Conclusion

From the above, it can be determined that the “Improved Internal Combustion Engine with Heat Exchanger” has the following advantages:

Operating on a constant temperature compression, constant pressure heating and expansion, constant temperature expansion, and constant pressure cooling cycle, Carnot cycle efficiency can almost be attained at any temperature, compression ratio, speed, or heat exchanger volume.

If in the above cycle heat is added to the hot compressed air at constant volume instead of constant temperature, then more work can be done with the heat that is added.

It changes the amount of air expanded by the engine to match the engine power to the load requirements.

When the load slows down it can save the inertia work and reuse it.

The compression and the expansion volumes can be separated. The heat from one will not effect the other.

1. An internal combustion, reciprocating engine comprising an air intake, a compressor, a compressor exit valve, a compressed air storage container, a heat exchanger high-pressure side, a power output shaft, a heat exchanger low-pressure side, an exhaust exit, an adjustable stop controller and similar working units, each working unit comprising:
a) a cylinder, closed at one end by a cylinder head;
b) said cylinder containing a movable power piston which moves in a reciprocating manner and is connected using a connecting rod to said power output shaft;
c) said cylinder containing a movable wall that is moved between a fixed stop and an adjustable stop by a bias spring;
d) an inlet valve;
e) an exit valve;
f) valve cams and valve push rods to move said inlet valve, and said exit valve;
g) a means to increase the heat in said cylinder.

2. An engine of claim 1 wherein said cylinder contains a movable pusher piston which moves in a reciprocating manner and is connected to said power output shaft using a connecting rod, and said cylinder also contains said movable power piston connected to said power output shaft using a telescoping connecting rod.

3. An engine of claim 1 wherein said cylinder contains a low power valve.

4. An engine of claim 1 wherein said means to increase the heat in said cylinder is the injection and burning of fuel.

5. An engine of claim 1 wherein said compressor is a multi-stage-intercooled compressor.

6. An engine of claim 1 wherein the inertia from the load slowing down is used to compress air that is stored in compressed air storage container for use at higher power.

7. An engine as recited in claim 1 having a cycle with the following processes:
a) air is compressed at close to constant temperature;
b) the compressed air is stored;
c) compressed air is heated by recovered exhaust heat at close to constant pressure;
d) only the amount of heated compressed air that is needed for the operating conditions of the engine is further heated by burning fuel at close to constant temperature;
e) air is expanded;
f) heat is recovered from the exhaust air at close to constant pressure.

8. An engine as recited in claim 1 having a cycle with the following processes:
a) air is compressed at close to constant temperature;
b) the compressed air is stored;
c) compressed air is heated by recovered exhaust heat at close to constant pressure;
d) only the amount of heated compressed air that is needed for the operating conditions of the engine is further heated by burning fuel at close to constant volume;
e) air is expanded;
f) heat is recovered from the exhaust air at close to constant pressure.

9. A process for operating the engine of claim 1 having the following steps:
a) the air is taken into said engine and compressed;
b) the compressed air is stored;
c) the compressed air from said compressed air storage container is heated by heat from the exhaust gases transferred by means of said heat exchanger high-pressure side and said heat exchanger low-pressure side;
d) said adjustable stop controller causes said adjustable stop to move to a position so that the engine power meets the load requirements;
e) when said power piston nears the top of its travel said exit valve closes, said inlet valve opens, and said heated compressed air is moved into a volume formed when said bias spring moves said movable wall up to said adjustable stop;
f) said inlet valve closes and the air is isolated in said cylinder;
g) said means to increase the heat in said cylinder heats the air;
h) the heated air exerts pressure on said power piston moving it down and creating power output;
i) as said power piston moves down the pressure in said cylinder decreases, when the pressure above said movable wall exceeds the pressure below said movable wall, said movable wall moves down to the fixed stop;
j) said power piston continues moving down to the bottom of its travel;
k) said exit valve opens;
l) said power piston moves up in said cylinder;
m) exhaust air moves out of said cylinder through said heat exchanger low-pressure side;
n) exhaust air heat is transferred from the exhaust air to heat exchanger low-pressure side to heat exchanger high-pressure side to the compressed air;
o) the exhaust air exits said engine;
p) the cycle repeats.

10. A process (low power) for operating the engine of claim 2 having the following steps:
a) the air is taken into said engine and compressed;
b) the compressed air is stored;
c) the compressed air from said compressed air storage container is heated by heat from the exhaust gases transferred by means of said heat exchanger high-pressure side and said heat exchanger low-pressure side;
d) said adjustable stop controller causes said adjustable to move to a position so that the engine power meets the load requirements;
e) when said power piston nears the top of its travel said exit valve closes, said inlet valve opens, and said heated compressed air is moved into a volume formed when said bias spring moves said movable wall up to said adjustable stop;
f) said power piston moves down;
g) said pusher piston moving up pushes said power piston back up toward the top of its travel, lengthening said telescoping connecting rod;
h) said inlet valve closes and the air is isolated in said cylinder;
i) the heated air exerts pressure on said power piston moving it down and creating power output while said means to increase the heat in said cylinder further heats the air in said cylinder;
j) as said power piston moves down the pressure in said cylinder decreases, when the pressure above said movable wall exceeds the pressure below said movable wall, said movable wall moves down to the fixed stop;
k) said power piston continues moving down;
l) said power piston stops moving down and said telescoping connecting rod lengthens when the pressure above said power piston nearly equals the pressure below said power piston;
m) as said power output shaft continues to turn, said telescoping connecting rod shortens completely and forces said power piston up in said cylinder;
n) said exit valve opens and exhaust air moves out of said cylinder through said heat exchanger low-pressure side;
o) exhaust air heat is transferred from the exhaust air to heat exchanger low-pressure side to heat exchanger high-pressure side to the compressed air;
p) the exhaust air exits said engine;
q) the cycle repeats.

11. A process (high power) for operating the engine of claim 2 having the following steps:
a) the air is taken into said engine and compressed;
b) the compressed air is stored;
c) the compressed air from compressed air storage container is heated by heat from the exhaust gases transferred by means of said heat exchanger high-pressure side and said heat exchanger low-pressure side;
d) said adjustable stop controller causes said adjustable stop to move to a position so that the engine power meets the load requirements;
e) when said power piston nears the top of its travel said exit valve closes, said inlet valve opens, and said heated compressed air is moved into a volume formed when said bias spring moves said movable wall up to said adjustable stop;
f) said power piston moves down;
g) said pusher piston moving up pushes said power piston back up toward the top of its travel, lengthening said telescoping connecting rod;
h) said inlet valve closes and the air is isolated in said cylinder;
i) the said means to increase the heat in said cylinder further heats the air in said cylinder;
j) the heated air exerts pressure on said power piston moving it down and creating power output;
k) as said power piston moves down the pressure in said cylinder decreases, when the pressure above said movable wall exceeds the pressure below said movable wall, said movable wall moves down to the fixed stop;
l) said power piston continues moving down;
m) said power output shaft continues to turn;
n) said telescoping connecting rod shortens completely and forces said power piston up in said cylinder;
o) said exit valve opens and exhaust air moves out of said cylinder through said heat exchanger low-pressure side;
p) exhaust air heat is transferred from the exhaust air to heat exchanger low-pressure side to heat exchanger high-pressure side to the compressed air;
q) the exhaust air exits said engine;
r) the cycle repeats.

12. A process for operating the engine of claim 3 having the following steps:
a) the air is taken into said engine and compressed;
b) the compressed air is stored;
c) the compressed air from said compressed air storage container is heated by heat from the exhaust gases transferred by means of said heat exchanger high-pressure side and said heat exchanger low-pressure side;
d) said adjustable stop controller causes said adjustable stop to move to a position so that the engine power meets the load requirements;
e) when said power piston nears the top of its travel said exit valve closes, said inlet valve opens, and said heated compressed air is moved into a volume formed when said bias spring moves said movable wall up to said adjustable stop;
f) said inlet valve closes and the air is isolated in said cylinder;
g) the heated air exerts pressure on said power piston moving it down and creating power output while said means to increase the heat in said cylinder heats the air;
h) as said power piston moves down, the pressure in said cylinder decreases, when the pressure above said movable wall exceeds the pressure below said movable wall, said movable wall moves down to the fixed stop;
i) said power piston continues moving down;
j) said low power valve opens if necessary to prevent a vacuum from forming in said cylinder;
k) said power piston moves to the bottom of its travel;
l) said exit valve opens;
m) said power piston moves up in said cylinder;
n) exhaust air moves out of said cylinder through said heat exchanger low-pressure side;
o) exhaust air heat is transferred from the exhaust air to heat exchanger low-pressure side to heat exchanger high-pressure side to the compressed air;
p) the exhaust air exits said engine;
q) the cycle repeats.

13. An internal combustion, reciprocating engine comprising a compressed air storage container, a second cooler, a heat exchanger high-pressure side, a power output shaft, a heat exchanger low-pressure side, an exhaust exit, an adjustable stop controller, and similar working units, each working unit comprising:
a) a cylinder, closed at one end by a cylinder head and containing a movable power piston which moves in a reciprocating manner and is connected to a power output shaft;
b) a movable wall located within said cylinder;
c) a bias spring for moving said movable wall during predetermined times during the engine's operating cycle;
d) an air intake and air intake port;
e) a displacer;
f) a compressor piston;
g) a means to move said displacer and compressor piston;
h) a compressor cooling system made up of said compressor piston, a lower compressor valve, a cooler, and an upper compressor valve;
i) a compressor exit valve;
j) an inlet valve;
k) a path from said compressor exit valve to said inlet valve containing said second cooler, said compressed air storage container, and said heat exchanger high-pressure side;
l) an exit valve;
m) a path from said exit valve to said exhaust exit of said working unit containing said heat exchanger low-pressure side;
n) a fuel injector;
o) an igniter;
p) an adjustable stop;
q) a means to open and close said valves.

14. An engine as recited in claim 13 wherein said means for moving said displacer and said compressor piston during predetermined times during the engine's operating cycle is a displacer cam follower and a compressor piston cam follower and a cam driven by said power output shaft.

15. An engine as recited in claim 13 having one or more compressor cooling systems, said compressor cooling system comprising said compressor piston, said lower compressor valve, said upper compressor valve, said cooler, said compressor piston cam follower and a groove in said cam.

16. An engine as recited in claim 13 wherein said displacer is constructed so that the hot and cold parts of the engine are separate from each other.

17. An engine of claim 13 wherein the inertia from the load slowing down is used to compress air that is stored in compressed air storage container for use at higher power.

18. An engine of claim 13 having a low power air intake port and low power valve.

19. A process for operating the engine of claim 13 having the following steps:
a) air intake that occurs from when said power piston uncovers said air intake port and moves through its bottom dead center position and moves back up to said air intake port; with said displacer, and said compressor piston moving up until the desired charge is in said cylinder, at the same time some exhaust through said heat exchanger low pressure side also occurs;
b) after said power piston covers said air intake port, said power piston, said displacer, and said compressor piston continue to move up pushing air out of said exit valve through said heat exchanger low pressure side until said displacer reaches the top of said cylinder, then said exhaust valve closes;
c) said power piston moves up, and comes together with said compressor piston, compressing the air between them and forcing the air through said cooler into the space between said compressor piston and said displacer;
d) said power piston and said compressor piston moving up together compress the air between said compressor piston and said displacer and force the compressed air through said compressor exit valve through said second cooler into said compressed air storage container;
e) the compressed air from said compressed air storage container is heated by heat from the exhaust gases transferred by means of said heat exchanger high-pressure side and said heat exchanger low-pressure side;
f) said adjustable stop controller causes said adjustable stop to position to meet engine power needs;
g) as said power piston nears the top of its travel said heated compressed air is moved into a volume formed when said bias spring moves said movable wall up to said adjustable stop;
h) said compressor exit valve and said inlet valve close, and the air is isolated in said cylinder;
i) fuel is injected and burned;
j) the heated air exerts pressure on said power piston moving it down and creating power output;
k) as said power piston moves down the pressure in said cylinder decreases, when the pressure above said movable wall exceeds the pressure below said movable wall, said movable wall moves down to the fixed stop;
l) said power piston continues moving down;
m) said power piston moves to the air intake port;
n) the cycle repeats.

20. An engine having a cycle with the following processes:
a) air is compressed at close to constant temperature;
b) the compressed air is stored;
c) said compressed air is heated by recovered exhaust heat at close to constant pressure;
d) only the amount of heated compressed air that is needed for the operating conditions of the engine is further heated by burning fuel;
e) the air that was further heated is expanded;
f) heat is recovered from the exhaust air at close to constant pressure.
